(19) United States
(12) Patent Application Publication
(10) Pub. No.: US 2026/0202362 A1
(43) Pub. Date: Jul. 16, 2026

(54) Transfer Module and Transfer Method for a Sample Material

(71) Applicant: Kammrath & Weiss GMBH, Schwerte (DE)

(72) Inventor: Konrad Weiss, Schwerte (DE)

(21) Appl. No.: 19/138,400

(22) PCT Filed: Nov. 13, 2023
(86) PCT No.: PCT/EP2023/081580

§ 371 Date: Jun. 12, 2025

(30) Foreign Application Priority Data
Dec. 12, 2022 (DE) 10 2022 133 028.1

(51) Int. Cl. G01N 23/2204; G01N 35/00; G01N 35/10

(52) U.S. Cl. CPC G01N 23/2204; G01N 35/10; G01N 2035/00277; G01N 2223/321

(57) ABSTRACT

The present invention relates to a transport module and method for moving a material sample between a first treatment space and a second treatment space; the module having a main body, an interior transport space, a closure element for closing the transport space, a sealing element for the sealing an abutment of the closure element, arranged circumferentially around the interior transport space, where the closure element is electromechanically drivable in order to open and close the transport space about said material sample.

### RELATED APPLICATIONS

This application is a national phase entry of PCT Application Serial No. PCT/EP2023/081580 filed Nov. 13, 2023, which claims the priority of DE Application Serial No. 10 2022 133 028.1 filed Dec. 12, 2022, all of which are hereby incorporated by reference.

### TECHNICAL FIELD

The present invention relates to a sample transfer system, module and method for transferring a material sample from one space to another.

### BACKGROUND

In the state of the art, transfer modules are known which are used for safely transporting a prepared sample along a transfer path between clean rooms and/or pre-treatment spaces and an examination space. The clean room and/or pre-treatment space can for example be a so-called glove box, which has a special atmosphere, and the examination and/or vacuum chamber can for example be the examination and observation space of a scanning electron microscope (SEM), a transmission electron microscopy (TEM) system, a high-resolution transmission electron microscopy (HRTEM) system or a light microscope. Here, the transfer module serves to prevent contact with oxygen, water and/or dust on the transfer path from the clean room and/or pre-treatment space to the respective examination space.

From JP4434901B2, such a transfer module is known, which has two inner chambers which can be hermetically separated from one another by an internal blocking device. Here, one chamber serves as a transport chamber and the other inner chamber serves as an airlock space. During the process of connecting to an examination space or a transport airlock, the airlock space of the transport module is suitably evacuated or flooded with an inert gas before the transport chamber is opened and the sample material is transferred into an adjacent examination space.

An alternative transfer module is disclosed by JP11201920A. Here, the inner chamber, into which the sample material has been introduced, can be hermetically closed off via a closure cover which can be lifted in parallel, and pivoted, via a lever mechanism. A further embodiment is known from CN107768221A, in which the closure cover is pivotable about an axis. A further solution is disclosed by JP6077812B2, in which the closure cover can be pushed substantially horizontally onto and off the top side of the transport chamber via a linear drive. Finally, CN212387290U discloses a solution which is opened and closed in the manner of a drawer, wherein the sample material is supported so as to be displaced with the drawer during the opening and closing.

These solutions, which are highly suitable in principle, have the disadvantage, however, that they require a relatively large volume in order to fully open so as to provide access to the inserted sample material, with the result that they cannot be utilized in all types of microscope and structurally complex transfer and/or airlock systems are necessary. It is furthermore disadvantageous that these transfer modules, which are generally manufactured from a noble metal, are very heavy relative to the inserted sample, with the result that very large weighing devices must be provided if the evacuated sample material has to be weighed together with the transport module.

### SUMMARY

The object of the present invention is to propose an improved transport module and a transport method which do not have the aforementioned limitations.

This object is achieved according to the invention by a transport module according to the features of claim 1, a transfer system according to the features of claim 11 and a transfer method according to the features of claim 13, wherein advantageous embodiments are specified in the respective associated dependent claims.

Accordingly, the object is achieved by a transport module for a test sample, having a main body, with at least one interior or transport space, and at least one single-part or multi-part closure element for closing the transport space, wherein a sealing element for the sealing abutment of the closure element is arranged circumferentially around the transport space, and the closure element is drivable in order to open and close the transport space, and wherein the main body has a longitudinal axis.

Here, the main body is formed cylindrical at least in the region of the longitudinal axis in which the transport space and/or the sealing element is arranged, and the closure element is formed at least in portions as a cylindrical sleeve and/or cylindrical shell portion and/or has such a portion. Furthermore, the closure element is supported such that it can be moved in a circumferential direction around the main body.

Owing to this construction of the transport module and of the circumferentially movable closure element, no additional volume for the closure element to be removed is necessary for an opening and a step of opening the transport space.

In the present case, by a transport module is meant in particular a module which can be brought manually or by suitable transfer and/or gripper elements from a first treatment space or location into or to a second treatment space or location without any connection to a base station or supply unit, wherein the transport space of the transport module is or can be fully encapsulated (closed). The transport module is in particular formed to maintain, for a defined period of time, a special atmosphere enclosed in the transport space by the closure element.

Here, the test sample is not to be understood limitatively and means any (sample) material, material pieces and any molded parts or groups thereof, including possibly necessary positioning elements, (test sample) carriers, (sample) holders etc. which can be permanently or temporarily arranged in the transport space for the purposes of safely and stably transferring a test sample therein. In the simplest case, the test sample is an element which is placed or laid flat and free on the bottom or base surface of the transport space.

The term “transport space” is likewise not to be understood limitatively and means any space with at least one base surface which can be closed by the closure element to form a space which is closed on all sides, in particular hermetically closed.

In the opened state, the transport space has at least one base surface and/or bottom side, and in the opened state advantageously also has at least two side walls or side surfaces.

The drive can in particular be a motor, such as an electric, electromagnetic and/or electromechanical motor, in particular a DC motor, which is part of the transport module. Alternatively, the drive, such as for example one of the aforementioned motors, can be arranged on or at the placement location for the transfer module, at which the latter is to be opened and/or closed, wherein a motor at this location can be coupled in a force-transmitting manner via a suitable transmission unit or a frictional element and acts on the closure element, with the result that the latter performs the opening or closing movement about the main body or the longitudinal axis. In the present case, a transmission unit, comprising at least for example one toothed ring, one toothed gear and/or one frictional element, may in no way be understood limitatively and means any suitable structural unit which can be connected in a force-transmitting manner to a motor and/or to a motor shaft.

The transmission unit can be at least partially attached to the transfer module and/or arranged at least partially at a placement location. Furthermore, “placement location” and “treatment space” are to be understood synonymously in the present case.

The motor can in particular be a DC motor, opened and closed. A contact plate, which transmits a control signal for stopping the drive in the fully closed closure position and/or in the fully opened working position, is advantageously arranged as a limit switch on the closure element and/or on the main body.

By the aforementioned “cylindrical” geometries is meant a substantially cylindrical geometry with usual manufacturing tolerances, and not a cylindrical shape in the mathematical sense.

The closure element can assume a closure position, in which the transport space is covered. Furthermore, the closure element can assume a working position, in which the closure element is arranged at least partially below the main body or below the transport space.

For this purpose, the main body, during intended use, when it has been secured at the installation location, has a free space below the main body and/or between the main body and the foot or base element, into or through which free space the closure element can be moved at least partially or over a partial distance.

This has the major advantage that the transport space can be opened and closed in an extremely small space without requiring additional volume. It is not necessary to provide a treatment space, for example within an SEM or TEM, for a closure element to pivot away or slide away.

The closure element in the form of a (closure) sleeve has an opening cutout, which advantageously substantially corresponds or is formed parallel to the border and/or outer edge of the transport space.

In an improved embodiment of the transport module, the closure element can be supported on the main body on both sides in the direction of the longitudinal axis for a circumferential movement.

It is advantageous here if the force transmission for the drive is effected only from one side of the closure element. The closure element is advantageously supported on the main body so as to be able to revolve completely, thus no change in direction is necessary for opening and closing.

It is advantageous here if at least the front edges of the closure element, which are oriented transverse to the circumferential and movement directions, are beveled. A longitudinal portion, arranged obliquely or transversely with respect to the movement direction, of the sealing element is thus elastically deformed in a gentle manner, and not damaged, when it is travelled over.

A further improvement can be that one or more locking elements are arranged on the main body and/or on the closure element, which prevent the closure element from unintentionally or accidentally opening. In particular, the locking element can be formed electrically driven and/or be coupled to the open-loop and closed-loop control unit of the drive (motor).

In a further, improved embodiment of the transport module, it can be provided that the closure element comprises or is connected to a toothed ring for force transmission.

Here, an advantage can be that the closure element comprises a toothed ring for force transmission, wherein the toothed ring is arranged either
on the circumference of the closure element, or
on the front edge or end face of the closure element or on an element connected thereto.

The teeth or the engagement elements of the toothed ring are advantageously arranged on the circumference and point in particular radially outward. Alternatively, the teeth or engagement elements can be arranged or the front edge of an end face or side surface, a side edge or an element connected thereto and can point in an axial direction.

The toothed ring is not to be understood limitatively in the present case and is also to include analogous transmission means, such as a row of holes consisting, for example, of rectangular openings in the closure element, into which a complementary counter-contour, such as a toothed gear or a toothed rack, can engage in a force-transmitting manner.

As already stated above, a transmission, toothed gear and/or another coupling device can be provided, which interacts in a force-transmitting manner with the toothed ring.

In a further, improved embodiment of the transport module, it can be provided that the transport space is formed as a cylinder cutout in the main body.

Here, “cylinder cutout” means a segment that is cut out substantially parallel to the longitudinal axis of the cylinder (main body) the shape of a cutout with a base surface at a height position of the cylindrical main body which has a diameter (D). Here, the height position (h) is the spacing of the base surface to the apex line of the cylinder (main body), and is less than the diameter, preferably less than or equal to ⅓ of the diameter, in particular less than or equal to ⅜ of the diameter. In other words, the cylindrical main body is not completely split or interrupted in a radial direction; a bar in the form of a horizontal cylinder segment remains in the region of the transport space.

Here, the height position is the vertical spacing of the base surface to the apex line of the main body, wherein the longitudinal axis of the main body, the perpendicular to the base surface, representing the height position, and the apex line span a common plane.

Here, the base surface
is oriented parallel or substantially parallel to the longitudinal axis of the cylindrical main body, and has a rectangular, square or circular basic geometry/structure,
the width corresponds to the width of the main body at least over a partial distance parallel to the longitudinal axis, in particular corresponds to the width of the cylindrical main body at the height position over the entire length.

The transport space shaped as a cylinder cutout furthermore has at least two side surfaces which are situated opposite one another in the direction of the longitudinal axis and which are perpendicular to the base surface or inclined with respect to the base surface, in particular are inclined relative to the base surface so as to point upward, i.e. away from the base surface.

It is immediately apparent to a person skilled in the art that the transport body can in principle assume any orientation or inclination. Since, during intended use, a person skilled in the art generally orients the transport module such that the base surface is perpendicular to the vertical, thus parallel to the horizontal, with the result that a sample/sample material can lie flat on it and can be examined, the base surface is to be arranged “at the bottom” in the transport space and the longitudinal axis of the main body is to run horizontally and parallel to the base surface.

These specifications and further specifications herein which use an orientation relative to gravity for description serve merely for the purposes of a textual description and do not represent a structural limitation. Analogous considerations apply to an expression such as “foot”, “head” or the like, which could also imply an orientation relative to gravity and which, in the present case, relate merely to a primary, gravity-related orientation of the transfer module, for example.

For accessibility by means of gripping elements and manipulators, it is particularly advantageous if, along the longitudinal edges of the base surface, there are no elevations or upwardly protruding boundaries but rather a flat, edge-free transition between the base surface and the cylinder lateral surface (outer surface) of the main body.

The volume or the cutout which forms the transport space can alternatively be described as a (material) cutout or (material) displacement which would theoretically arise if
a square or rectangular punch, which projects vertically above the upper apex line of the horizontal cylindrical main body, were driven transversely through the main body at a height h which is smaller than the diameter thereof,
a punch with a trapezoidal cross section were analogously driven transversely through the main body, wherein in particular the wider side of the trapezoid (foot side) would be arranged at the top, or
a cylindrical milling cutter were guided perpendicularly from above in the direction of the longitudinal axis, with the result that the bottom edge of the cylindrical milling cutter, when in the lowest position, forms the base surface.

In order to create as flexible and versatile as possible a use and examination possibility, it can be provided in a further, improved embodiment of the transport module that the transport space has at least one gas connection. The gas connection and possibly necessary valves/connections serve to generate, in the transport space, a specific special atmosphere which differs from the special atmosphere in which the transport space was closed.

In the present case, in particular a vacuum in which negative pressures down to a few mbar are attained, such as is known and usual for the respective examination method, is to be regarded as a special atmosphere. Furthermore, by a special atmosphere is meant any defined gas or gas mixture which in particular differs from air and/or a gas mixture composed of the main components oxygen (O2) and nitrogen (N2). In particular, by a special atmosphere is meant a gas or gas mixture the majority of which is an inert gas or inert gas mixture, such as CO2, N2 and/or noble gases. Furthermore, by a special atmosphere is meant a gas or gas mixture which is free or substantially free from vapor portions, in particular free from water vapor.

In this way, for the transfer of the transport element, for example either a vacuum from the first treatment space can be enclosed when the sample material is closed in the transport space. If the thus-closed transport module is conducted into normal atmosphere, the external pressure of approximately 1 bar securely closes the transport module. In a subsequent, second treatment space, the vacuum can be released by virtue of a vacuum being generated again in the second treatment space and the closure element being opened, which is easy to implement owing to the equal or similar pressure conditions. Alternatively or in addition, as an additional conditioning step, an inert gas or gas mixture can be introduced into the transport space.

A person skilled in the art is presented with further possibilities for examination, for example by virtue of a defined quantity of a reactive or oxidative fluid (gas, vapor, liquid) being introduced into the evacuated transport space (reaction atmosphere) and acting on the test sample there for a defined period of time. Subsequently, this test sample, which has thus been reactively conditioned in a reaction atmosphere, can be inertly conditioned or evacuated again in the transport space and/or, through an opening step, provided for an examination in for example a treatment space of an SEM.

Supplementing this embodiment, an inlet and a separate outlet for a fluid can be provided, such as for example for an inert gas or an inert gas mixture, wherein necessary fittings and lines can be provided.

Ideally, an inlet and/or an outlet is arranged in a side surface or in each case one of the side surfaces of the transport space. In a particularly advantageous embodiment, at least one line, which leads to an inlet and/or an outlet, is led through the interior space of the main body to the rear side, facing the interior space, of the side surface of the transport space and is connected or connectable to an inlet or outlet situated there.

In a further, improved embodiment of the transport module, it can be provided that circumferentially around the transport space a seal groove is formed, the spatial or profile geometry of which is three-dimensional.

Here, it can be particularly advantageous if, during the circulation along the longitudinal axis of the seal groove, the latter has a spatial or profile geometry in a Cartesian coordinate system which has variations in the x, y and z directions. Here, the seal groove advantageously has two longitudinal portions, which run below the longitudinal edges of the base surface, and
two sheath portions, which run parallel to the side edges and/or at the same (average) height position of the side edges. Here, the longitudinal edges ideally describe two straight and mutually parallel portions of the seal groove and the two sheath portions describe two circular arcs which are perpendicular, or inclined outward, relative to the longitudinal portions.

In the present case, by the profile of a sheath portion which lies “at the same and possibly average height position” of the side edges is meant that, when viewed in the direction of the longitudinal axis, the respective side edge lies or runs in the shadow area of the respective sheath portion of the sealing element and/or of the seal groove, in particular has a substantially constant height position within the shadow area of the sealing element and/or of the seal groove.

The transition from a longitudinal portion to a sheath portion of the seal groove is formed in each case by a transition portion. The transition portion can advantageously comprise an arc in two spatial directions.

An annular or ring element composed of an elastically deformable material is advantageously provided as a sealing element, such as for example an O-ring seal composed of a rubber material, a Teflon material etc. The sealing element advantageously projects above the associated wall or side surface by approximately 0.2 mm, up to at most 3 mm, after being inserted.

It has proved to be a particular advantage that, in particular in the case of a closure element in the form of a (closure) sleeve, in which the opening cutout or the boundary of the opening cutout is formed substantially congruent with and/or directly adjacent to the border and/or outer edge of the transport space, the sealing element is permanently covered.

In other words, the entire sealing element is completely covered in the closure position, as is known, but according to an advantageous embodiment also in the working position. Also, during the movement from the closure position into the working position, only the longitudinal portion of the seal groove and of the sealing element there is temporarily exposed. It has thus proved to be a particular advantage that, in particular in the critical working position, the sealing element is largely protected against environmental influences by the covering closure element.

In a further, improved embodiment of the transport module, it can be provided that the main body has a base/foot element, which will hereinafter only be referred to as “foot element”. This foot element can furthermore advantageously have a guide or rail geometry and/or at least one side element.

The one or two side elements advantageously serve to hold the main body, wherein the aforementioned free space is formed between the main body and the standing surface or the foot element, into or through which free space the closure element can be moved at least partially or over a partial distance.

Furthermore, for connection, the foot element can comprise a complete coupling device or a part of a coupling device. This can be formed as a rail or a clamp or in another suitable form. In particular, it is advantageous if the coupling device is formed as a dovetail element with a receiving rail and a guided rail, wherein one of the rails is secured to the foot element. By the guided rail is meant here the rail that is arranged on the transport module. The receiving rail is the rail that is arranged in the treatment space and/or in a supporting or holding element there and serves to receive the guided rail.

The associated complementary rail of the coupling device can be suitably arranged on the standing surface of the treatment space and/or a supporting or holding plate there. In an improved embodiment, a locking element is arranged on the foot element, the coupling device and/or an adjacent holding element, with the result that the parts of the coupling device can be clamped and/or braced against one another.

The rail arranged on the foot element advantageously has, at the free end, a clamping surface inclined with respect to the longitudinal axis of the rail and oriented transverse thereto. Furthermore, a locking element is provided, which is arranged on the adjacent holding element or the further rail and has a complementary oblique clamping counter-surface. Here, the locking element can be screwed or braced, for example by means of two screws guided and received parallel to the rails, such that by the complementary oblique surfaces the guided rail is pushed into an axial end position of the receiving rail and simultaneously clamped in a transverse direction.

In a further, improved embodiment of the transport module, it can be provided that the main body has a foot element, which has a motor as a drive for the circumferential movement of the closure element.

Here, the motor can for example be formed as an electric, electromagnetic and/or electromechanical motor. The transfer of force to the closure element and/or an element, such as a toothed ring, coupled to the closure element can be effected via a transmission unit, which in the simplest case is a toothed ring or contact band arranged on the motor shaft.

The transfer module advantageously has an interface unit, in particular an interface unit in the form of a docking station, via which open-loop and closed-loop control data and/or the electrical supply for the drive can be transmitted.

In a particularly advantageous embodiment, the drive is an electromagnetic direct drive which does not require a transmission unit.

Overall, it is advantageous if the transport module is very dimensionally stable and very lightweight. An improvement of an embodiment of the transport module can thus be that the main body has an interior space.

In other words, it can be advantageous if the main body is not a solid piece of material, but rather has at least one interior space, thus is at least partially hollow and/or has, for example, a cylindrical interior space.

It has proved to be advantageous here if, in front of and behind the portion in which the transport space is arranged, in the direction of the longitudinal axis, the interior space is formed as a hollow cylinder or tubular portion. Furthermore, for further weight reduction, it can be advantageous if a further transition space is arranged in the main body, which further transition space connects the two hollow cylinders or tubular portions to one another and runs parallel to the transport space or extends in the longitudinal axis section in which the transport space is also arranged. This transition space can in particular be formed as a horizontal cylinder segment. The mutually parallel wall elements of the main body advantageously have the same or substantially the same wall thickness.

With the exception of possibly arranged valve and/or leadthrough elements for a connection line, there is no direct connection between the transport space and the interior space.

The particular advantage of this embodiment is that it is particularly lightweight and nevertheless very dimensionally stable. Weighing operations and handling are thus greatly simplified overall.

The invention furthermore includes a transport system which has a transport module and a base station, wherein the transport module and the base station have at least one coupling device or are distributed parts of a common coupling device, by means of which the transport module can be at least temporarily fixed in a defined position to or on the base station. Here, the transport module is formed according to one of the above variants and embodiment examples.

An improvement of the transport system can be that the base station has a drive as a motor or a drive as a combination with a motor with at least one part of a transmission unit, via which the closure element of the transport module can be driven circumferentially in relation to the main body and/or the longitudinal axis of the main body.

If the base station comprises the motor and/or the housing, the transfer module can be further simplified and thus formed even more lightweight and even smaller. The transmission of force is advantageously designed such that, through the attachment or introduction of the transport module to or into the base station, in particular a coupling device there, the transmission of force from the motor and/or from a transmission of the base station to the closure element and/or the drive element there of the transport module, such as the toothed ring, is also effected.

In this embodiment the transfer module thus advantageously no longer needs to be electrically connected in a treatment space, whereby sources of interference are eliminated and the transport module is constructed structurally simpler.

If the drive is arranged as a motor in the base station, it can be conceived in a greater structural variety because it can be arranged entirely or partially outside the treatment space.

A possible drive can for example be a linearly movable, guided and driven toothed rack, which is brought into force-transmitting engagement with the toothed ring arranged on the closure element. The driving motor can be accommodated outside the treatment space or in a supporting or holding element of the base station.

The invention furthermore includes a transfer method for transferring a test sample, in particular in a first protective atmosphere, wherein the following steps are included:
loading step (b), comprising the fact that the test sample, within a first treatment space, is introduced into a transport space of a main body of a transport module,
closure step (d), wherein the closure of the transport space is effected with a closure element of the transport module,
transfer step (f), wherein a transfer of the closed transport module into a second treatment space is effected,
opening step (h), wherein an opening of the transport space is effected through a removal of the closure element within the second treatment space, and wherein a further protective atmosphere prevails and/or is established as required in the transport space and/or the second treatment space.

The opening step (h) can advantageously be followed by a further treatment step (i), which comprises the fact that the test sample is examined, in particular is examined by means of a microscope or is at least partially treated, analyzed or manipulated in another way.

In the present case, the designation of first, second or further protective atmospheres is not to be understood limitatively. For example, the second protective atmosphere can be identical to the first protective atmosphere, and can in particular have been newly established in a further treatment space.

Here, the transport module and/or its main body has a cylindrical portion at least in the region of the transport space and/or adjacent to the transport space, wherein the closure element is moved in a circumferential direction of the transport module and/or its main body in order to open and/or close the transport space.

By a “treatment space” is meant here the space, the location or the station where the sample material is treated, manipulated, tested and/or inspected, for which purpose the transport space has to be opened or open. The sequence of the treatment spaces is in principle not to be understood limitatively, wherein, in a usual sequence, the first treatment space is a so-called glove room, in which a test sample or a surface of a test sample is treated, for example ground or etched, under sterile and/or clean room conditions, possibly with a protective gas atmosphere. In some cases, a vacuum chamber is present in the first treatment space, by means of which vacuum chamber the transfer module with the test sample can be closed under a vacuum atmosphere. The second treatment space is usually the vacuum examination space of a microscope, such as an SEM or TEM. This can be followed by further treatment spaces.

In an embodiment of the transport method, in the first treatment space, an opening step analogous to that for the second treatment space (a=h) is effected before the loading step (b), if the transport module is introduced in a closed state into the first treatment space.

The method can be developed or improved to the effect that, in the second treatment space, a closure step (j) analogous to the closure step (d) is effected, in particular an analogous closure step (j) is effected after the treatment step (i).

A further improvement can be that, in the first treatment space and before the opening and/or loading step there, a coupling step (k) is effected, in which the transport module is coupled into or onto a coupling device and in particular is braced and/or clamped there.

In an improvement of the method, it can be provided that at least one conditioning step (f) is carried out, which is effected, in terms of time,
after the loading step (b) and before the opening step (h) in the second treatment space or
in parallel with the opening step (h) in the second treatment space, by virtue of a third protective atmosphere being established in the transport space.

Overall, it is advantageous for the transfer method if the transport module is formed according to one of the above embodiments and variants. A further improvement can be if the transport system according to the above variants and embodiments is used.

It may also be pointed out that, in the context of the present patent application here, indefinite articles and indefinite numerical figures such as “one . . . ”, “two . . . ” etc. are generally to be understood as minimum figures, thus as “at least one . . . ”, “at least two . . . ” etc., unless it is apparent, for instance from the context or the specific text of a particular passage, that for instance only “exactly one . . . ”, “exactly two . . . ” etc. is to be meant there.

It may also be pointed out at this juncture that, in the context of the present patent application here, the expression “in particular” is always to be understood such that an optional, preferred feature is introduced with this expression. The expression is not to be understood as meaning “specifically” or “namely”.

The term “single-piece” preferably means that the element described thereby forms an individual, in particular separately handleable element and individual constituent parts thereof cannot be separated without the element being destroyed in the process. Preferably, individual constituent parts of the element described as being “single-piece” are connected to one another in a material-bonding manner.

### BRIEF DESCRIPTION OF THE DRAWINGS

Further details and advantages of the invention are now discussed in more detail on the basis of an embodiment example represented in the drawings, in which:

FIG. 1 shows a three-dimensional view of the transport module in a first embodiment in the working position;

FIG. 2 shows a further three-dimensional view of the transport module according to FIG. 1 in the first embodiment in the working position;

FIG. 3 shows a further three-dimensional view of the transport module according to FIG. 1 in the first embodiment in the closure position;

FIG. 4 shows a vertical sectional representation of the embodiment according to FIG. 1 parallel to the longitudinal axis; and

FIG. 5 shows a vertical sectional representation of the embodiment according to FIG. 1 transverse to the longitudinal axis.

### DETAILED DESCRIPTION

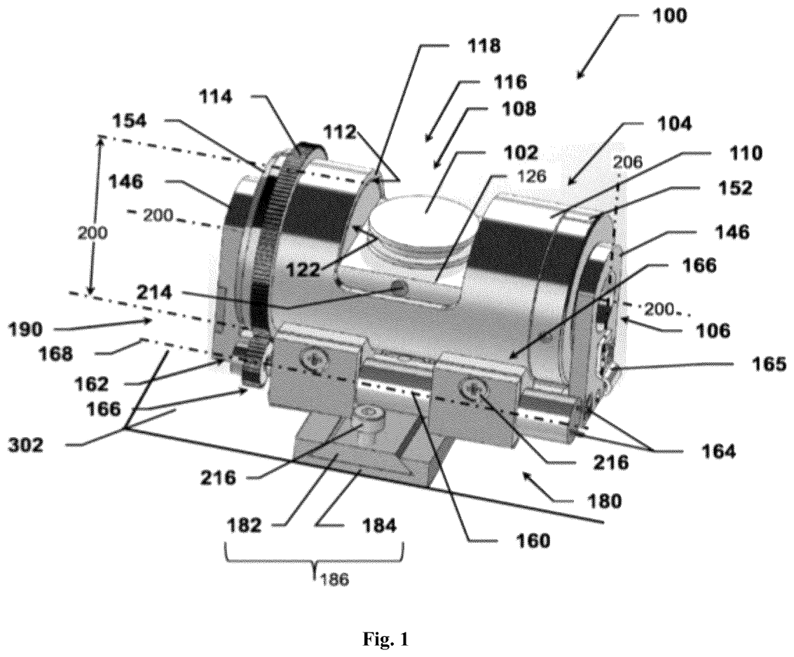

In FIG. 1 the transport module 100 for a test sample 102 is represented, which transport module has a substantially cylindrical main body 104, with a longitudinal axis 200 and a transport space 108, a closure element 110, a sealing element 112, a toothed ring 114 and a foot element 180. The closure element 110 has, on one side on the left-hand side, a toothed ring 114, which is perpendicular to the longitudinal axis 200 and is arranged on the cylindrical lateral surface of the closure element 110 over the entire circumference. The teeth of the toothed ring 114 protrude radially outward. The test sample 102 represented is in this case merely a carrier element and during intended use is overlaid or pasted with the actual sample material or substrate to be examined.

The closure element 110 is rotatably supported at one side of the main body 104 on a bearing and closure unit 152 and is supported at the other end of the main body 104 on a bearing unit 154, not represented in more detail. The bearing and closure unit 152 can be opened and closed for the purposes of being installed on or around the main body 104.

Two side elements 146 and a support unit 166 for the motor 160 are arranged on the foot element 180. Furthermore, the foot element 180 is connected to a guided rail 182 of a coupling device 186, wherein the receiving or guiding rail 184 is secured on a standing surface 302 directly or indirectly via a support or holding element, not represented.

The main body 104 is secured on both sides to in each case one side element 146, which can be supported by the foot element 180. The motor 160 is oriented with its axis of rotation 168 parallel to the longitudinal axis 200 of the main body 104 and held by the support unit 166. The motor 160 is a DC motor, which at its rear end has two connecting contacts 164 and at the opposite end has the drive shaft, on the end of which a transmission unit in the form of a toothed gear 162 is arranged. An earth connection 165 is arranged on a side element 146.

The terminal toothed gear 162 of the drive shaft of the motor 160 is in force-transmitting engagement with the toothed ring 114 of the closure element 110.

The transport module 100 is represented in a working position, in which the closure element 110 is fully open upwardly and opens up the entire transport space 108. The vertical 206 is perpendicular to the longitudinal axis 200, wherein the foot element 180 is arranged at the bottom and the test sample 102 is arranged at the top.

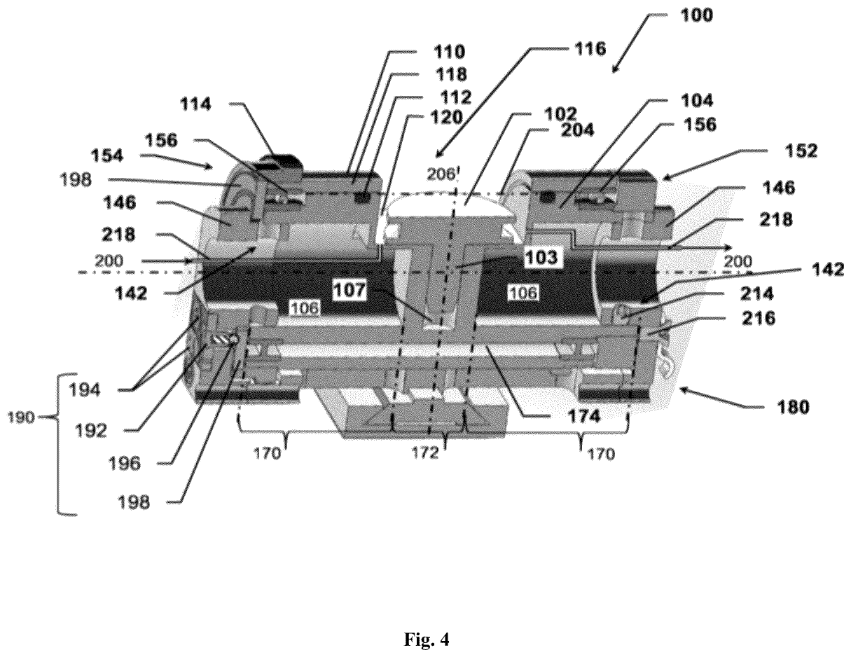

A free space is arranged inside the closure element 110 toward the foot element 180 and toward the support unit 166 of the motor 160, with the result that the closure element 110 is rotatable in a collision-free manner about the main body 104. Furthermore a switching unit 190 is included, which is described with further details in conjunction with FIG. 4. This switching unit 190 is formed as a limit switch, with the result that a control signal for stopping the motor 160 is transmitted in the fully closed closure position and/or the fully opened working position.

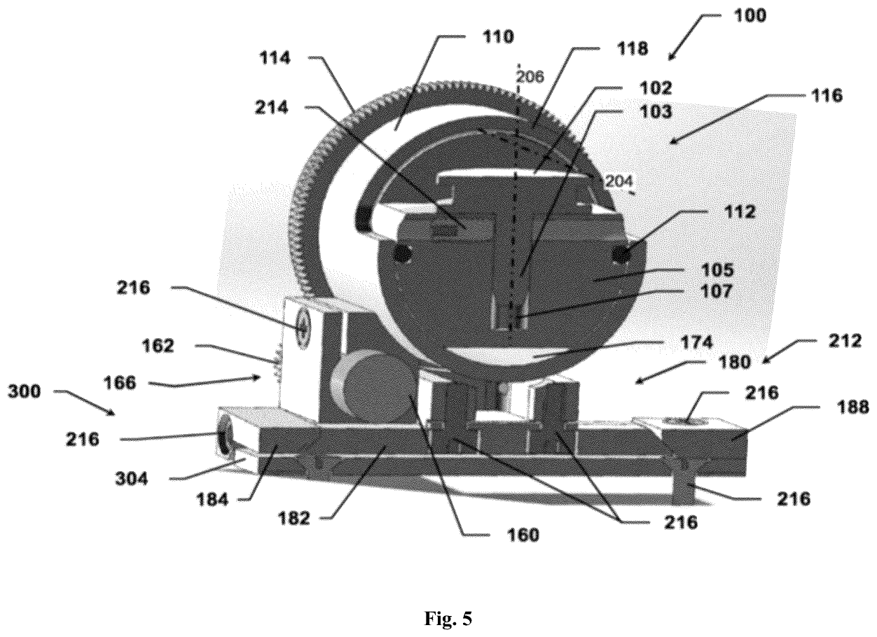

The test sample 102 formed as a disk has, centrally on the underside, a transport pin, represented in detail in FIGS. 4 and 5, which is positioned in a bore 107 of the main body 104 and clamped via the frontal grub screw 214. Here, the bore with the nut thread for the grub screw 214 is introduced into the main body 104, the outer side of which projects above the lower-lying boundary 118 of the closure element 110 in the direction of the longitudinal axis and transitions, at the common longitudinal edge 126, into the base surface 120.

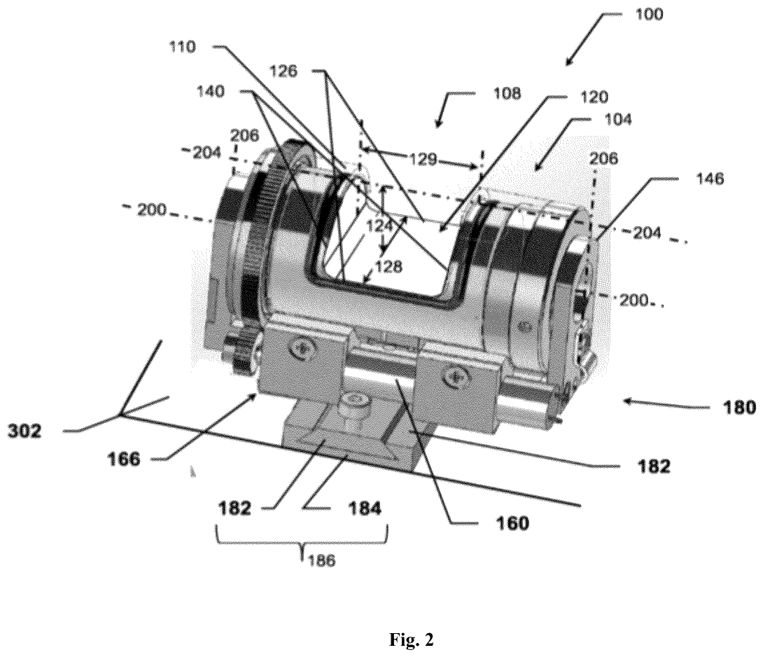

As represented in FIG. 1, the boundary 116 of the opening cutout 116 runs in alignment with the outer edges of the transport space 108, and the sealing element 112 is completely covered even when the closure element 110 is in the fully opened position, as is also represented with more details in FIG. 2.

It can furthermore be seen that the transport space 108 is advantageously accessible barrier-free in a direction transverse to the longitudinal axis 200, with the result that the test sample 102 is accessible in the transport space 108 without obstruction. In the case of a freely supported test sample 102, this could be pushed off barrier-free and for example brought onto an adjacent conveying or treatment element, without the use of a gripping or lifting element.

The transport module 100 represented in FIG. 2 corresponds to that in FIG. 1, wherein the closure element 110 has been removed or is represented merely as a grid, with the result that the seal groove 130 arranged underneath it and the sealing element 112 placed therein can be seen. The seal groove 112 has two longitudinal portions 132, two sheath portions 134 and four transition portions 136, wherein only the front longitudinal portion 132, the two sheath portions 134 and two of the four transition portions 136 are represented in the view of FIG. 2. The basic structure of the transport space 108 is substantially symmetrical with respect to the perpendicular central plane, which is spanned by the vertical 206, the longitudinal axis 200 and the apex line 204.

The transport space 108 has the shape of a horizontal cylinder segment, with a base surface 120 and two side surfaces 122 perpendicular thereto. The base surface 120 has a spacing to the apex line 204 at a height position 124 which corresponds to ⅜ of the diameter 202 of the main body 104. Thus, the width 128 of the base surface 120 according to the circle equation is as follows:

$$B = 2 \cdot {( h \cdot ( D - h ) )}^{⋀ 0.5}$$

wherein:
B: width 128
D: diameter 202
h: height position 124

Furthermore, in the present example, the base surface 120 has a substantially square basic shape, with the result that the length 129 substantially corresponds to the width 128, aside from a beveled transition region with a defined radius in the abutting edge between the base surface 120 and the side surfaces 122.

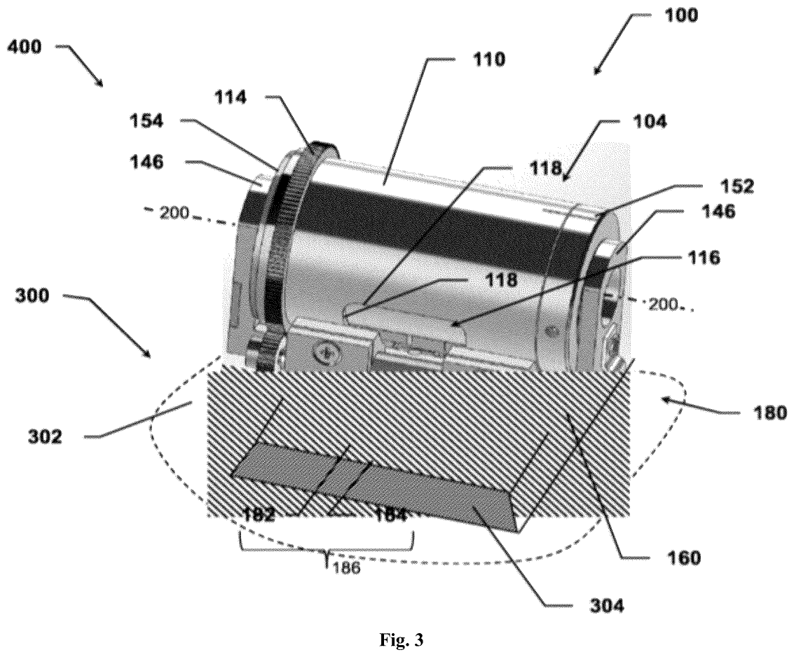

FIG. 3 shows the transport system 400 with a schematically represented base station 300, a standing surface 302 and a plate-like support and holding element 304, on which the guiding rail 184 of the coupling device 186 is secured in a not represented manner. The guided rail 182 of the coupling device 186 can be clamped against the guiding rail 184 via a screw guided perpendicularly through them.

The embodiment of FIG. 3 corresponds to that of FIGS. 1 and 2, with the result that the designs there are to apply analogously or identically.

The transport element 100 in the representation of FIG. 3 is shown in the closure position, in which the closure element 110 has been rotated in a circumferential direction about the main body 104 such that the opening cutout 116 is situated at the bottom, below the main body 104 and also below the transport space 108, not represented. The front edge 118 of the opening cutout 116 is situated below the longitudinal portion 132 of the seal groove 130 or of the sealing element 112 there.

The otherwise sleeve-like closure element 110 completely covers the transport space 108 and, for a defined period of time, securely encloses the special atmosphere created in the transport space 108 before the closure. In the embodiment, the special atmosphere, such as for example a vacuum or a noble gas, can be maintained for up to 3 hours.

The vertical sectional representations in FIGS. 4 and 5 show the analogous embodiment of the transport module according to FIGS. 1-3.

In particular, FIG. 4 shows the main body 104, the two side elements 146, the foot element 180, the coupling device 186, the closure element 110 and the test sample 102. Furthermore the toothed ring 114 arranged on the circumference of the closure element 110 is represented. The bearing and closure element 152 and the bearing element 154 in each case comprise or delimit a bearing 156. In the example shown, the bearings 156 are formed as ball bearing rings, wherein a roller bearing mounting or a plain bearing mounting could also be provided. Ball bearings or roller bearings are advantageous with regard to the low resistance.

The two side elements 146 in each case have a ring portion 142 projecting into the interior space 106 of the main body 104. A bore with an internal thread is arranged in at least one of the ring portions 142, via which the ring portion 142 can be braced together with the main body 104 and/or the bearing and closure element 152 by means of a grub screw 214. Furthermore, through the support in the ring portion 142, the main body 104 can be very easily oriented in terms of the orientation relative to the foot element 180.

In the direction of the longitudinal axis 200, the main body 104 comprises two tubular portions 170 and a bar portion 172, wherein the bar portion 172 is arranged between the two outer tubular portions 170 and has a bore 107, which for receiving and fixing a securing pin 103 of the test sample 102 or of a carrier element (not represented) fixing the test sample 104. The main body 104 furthermore has a flattened portion on the underside. This is attached to the entire length with respect to the bar portion 172 or transport space 108 and the tubular portions 170, with the result that an intermediate space 174 is formed between this flattened portion and the main body 104.

This intermediate space 174 serves in particular for pressure equalization in the trapped gas volume in the gap under the closure element 110 and for further weight reduction of the entire transport module 100.

In contrast to the variants represented in the preceding figures, two fluid lines 218 are provided, which lead into the transport space 108. The two fluid lines 218 are in each case led through the interior space 106 of a tubular portion 170. The left-hand fluid line 218 leads through the base surface 120 into the transport space 108 and the right-hand fluid line leads to a wall portion of the side surface 122 and into the transport space 108. A possible flow direction is indicated by the directional arrows. Other necessary elements, such as for example valves, shut-off elements, pumps, reservoirs or all elements of a necessary measurement technology and technology, are not represented.

Furthermore, FIG. 4 shows a switching unit 190, which is formed as a sliding contact unit. This has an outer contact and conductor ring 198, and a contact element 192 which is connectable to the two connection elements 194 for the associated control lines (not represented). The outer contact and conductor ring 198 has two conductor tracks, not described in more detail. The contact element 192 is in electrically conductive and data-carrying contact with these conductor tracks by means of a spring-loaded contact ball 196. The advantage of a contact ball 196 is that wear proves to be greatly reduced relative to a stationary, non-supported sliding head.

For further reduction of the weight, the outer contact and conductor ring 198 also forms the outer cover of the bearing unit 154.

The embodiment example according to FIG. 5 corresponds to that of FIG. 4 aside from the absence of the fluid lines 218, with the result that reference is made thereto in particular in the present case.

The transport module 100 is constructed as described above and in particular comprises a main body 104, a closure element 110, a motor 160 and a foot element 180. Here, the foot element 180 and the base station 300 are connected via the coupling element 212.

The base station 300 comprises the guiding rail 184 and a support or holding element 304. This support or holding element 304 can be part of a treatment space, for example of a microscope, or can represent a standalone element independent of the respective treatment space. The support or holding element 304 is secured, in a manner not represented in more detail, by means of screws 216 or can be secured at the placement location by means of screws 216.

In the example shown, the guiding rail 184 has, on the left-hand side, a stop with an overhanging bevel, against which the guided rail 182 has been pushed, which likewise has a complementary bevel/bevel surface on the end side. On the right-hand side, the guided rail 182 has a further clamping geometry. This clamping geometry is in the present case a further bevel, on which a clamping element 188 bears with a complementary oblique surface. This clamping element 188 is clamped on under the action of force by means of a vertically guided screw 216. The guided rail 182 is thus pressed in a horizontal direction and in a vertical direction on the guiding rail 184 and/or the support or holding element 304.

The transport module 100, which is formed substantially from metallic elements, is suitable for a standard SEM test sample smaller than 14 mm and, in the embodiment described above, without the guided rail 182, has a height of from 40 to 45 mm and a total weight of from 45 to 55 grams.

Although in the present case primarily the transport module, the base station and the transport system have been described on the basis of the figures, all of the named advantages and aspects are also to apply identically or analogously to the transport method, and vice versa where reference has been made to the method.

### LIST OF REFERENCE NUMBERS

100 transport module
102 test sample
103 securing pin
104 main body
106 interior space
107 bore
108 transport space
110 closure element
112 sealing element
114 toothed ring with teeth
116 opening cutout
118 boundary of 116
120 base surface
122 side surface
124 height position (h)
126 longitudinal edge
128 width (B) of the base surface
129 length (L) of the base surface
130 seal groove
132 longitudinal portion
134 sheath portion
136 transition portion
140 side edges
142 ring portion
146 side element
148
150 guide or rail geometry, in the microscope
152 bearing and closure unit
154 bearing unit
156 bearing
160 motor
162 toothed gear
164 connecting contact
165 earth connection
166 support unit
168 motor axis
170 tubular portion
172 bar portion
174 intermediate space
180 foot element
182 rail, guided
184 rail, guiding
186 coupling device
188 clamping element
190 switching unit
192 contact element
194 connection element
196 contact ball
198 contact and conductor ring
200 longitudinal axis
202 diameter (D)
204 apex line
206 vertical
212 coupling element
214 grub screw
216 screw
218 fluid line
300 base station (BS)
302 standing surface
304 support or holding element
400 transport system

What is claimed is:

1-15. (canceled)

16. A sample transport module, comprising:
a main body having a cylindrical portion and defining a longitudinal axis thereof,
a transport space within said main body; and
a closure element comprising a cylindrical shell portion configured and arranged to circumferentially move with respect to said man body to open and close said transport space at a circumferential sealing element thereof.

17. The sample transport module of claim 16, wherein said closure element is supported at two ends thereof by said main body.

18. The sample transport module of claim 16, wherein said closure element comprises or is coupled to a circumferential toothed ring.

19. The sample transport module of claim 16, wherein said main body comprises a cylindrical cutout defining said transport space.

20. The sample transport module of claim 16, further comprising a fluid line coupled to said transport space.

21. The sample transport module of claim 16, further comprising a circumferential seal groove accommodating said sealing element.

22. The sample transport module of claim 16, further comprising a foot element coupled to a guiding rail and a guided rail that supports and translates said main body.

23. The sample transport module of claim 16, further comprising a motor that drives said closure element in a circumferential direction to open or close said transport space.

24. The sample transport module of claim 20, said fluid line disposed in an interior space within said main body.

25. The sample transport module of claim 23, further comprising a limit switch, electrically coupled to said motor, and operable at a limit of circumferential movement of said closure element.

26. A sample transport system, comprising:
a sample transport module according to claim 16; and
a base station;
wherein sample transport module coupled to said base station by a coupling device configured and arranged to fix said transport module with respect to said base or to translate said transport module with respect to said base.

27. The sample transport system of claim 26, said base station comprising a motor and a transmission unit that drive said closure element of the transport module in a circumferential direction with respect to said main body of the transport module.

28. A method of transferring a sample, comprising:
loading a sample, in a first protective atmosphere, from a first treatment space into a transport space defined in a cylindrical portion of a sample transport module;
closing said transport space with a circumferential closing movement of a closure element of the sample transport module;
moving said sample transport module from said first treatment space to a second treatment space;
opening said transport space, in a second protective atmosphere of said second treatment space, with a circumferential opening movement of said closure element of the sample transport module.

29. The method of claim 28, further comprising a conditioning step after said closing step and before said opening step, the conditioning step comprising establishing a third protective atmosphere within said transport space.

30. The method of claim 28, wherein said sample transport module comprises the sample transport module of claim 16.
